(19) United States
(12) Patent Application Publication
(10) Pub. No.: US 2011/0238938 A1
(43) Pub. Date: Sep. 29, 2011

(54) EFFICIENT MIRRORING OF DATA ACROSS STORAGE CONTROLLERS

(75) Inventors: John R Kloeppner, Buhler, KS (US); Mohamad El-Batal, Westminster, CO (US)

(73) Assignee: LSI Corporation, Milpitas, CA (US)

(21) Appl. No.: 13/127,055

(22) PCT Filed: Oct. 30, 2008
(86) PCT No.: PCT/US08/81658

§ 371 Date: May 31, 2011

(51) Int. Cl. G06F 12/16

(52) U.S. Cl. 711/162; 711/E12.103

(57) ABSTRACT

A method includes multicasting an Input/Output (I/O) data associated with a host computing device through a multicast device associated with a storage controller coupled to another storage controller in a redundant configuration, and minoring, through the multicasting, the I/O data across the storage controller and the another storage controller through a bus utilized to couple the storage controller and the another storage controller. The method also includes transmitting an early write status message to the host computing device following the minoring of the I/O data across the storage controller and the another storage controller. The early write status message is associated with a successful completion of the mirroring of the I/O data across the storage controller and the another storage controller prior to the I/O data being written to a storage device associated therewith.

### CLAIM OF PRIORITY

This is a national phase utility application and claims priority from PCT Application Number PCT/US08/81658 titled “STORAGE CONTROLLER DATA REDISTRIBUTION” filed on Oct. 30, 2008.

### FIELD OF TECHNOLOGY

This disclosure relates generally to storage systems and, more particularly, to efficient mirroring of data across storage controllers.

### BACKGROUND

In a storage system, a storage controller may be paired with another storage controller (e.g., as a mirror or a dual controller) in a redundant configuration such that if one of the storage controller fails, the other storage controller may have access to one or more storage devices (e.g., disks) associated therewith. Each of the storage controllers may have the capability to provide Input/Output (I/O) writes. An I/O write includes data from a host computing device that may be written to the one or more storage devices coupled to the storage controllers. As part of the I/O write, one (or, both) of the storage controllers may return a status message associated with the completion of the write processes to the host computing device.

When the completion is a success as indicated through the status message, the host computing device may proceed with other tasks associated with the normal operation thereof. When the completion is a failure as indicated through the status message, the write operation(s) may be retried or a system fault may be created. In order to reduce latency associated with the generation of the status message, the storage controller may return the status message associated with a successful completion prior to the data being written to the one or more storage messages. However, if the storage controller including the write data fails prior to the data being written to the one or more storage devices, the data may be lost.

In order to eliminate the loss of data in the aforementioned scenario, the mirroring process may start with the storage controller accepting I/O write data from the host computing device and writing the aforementioned data to a memory associated therewith. The storage controller may then read the data from the memory and write the data to a memory associated with the other storage controller. As the memory on a storage controller may offer limited performance, the memory read process inherent in the mirroring may limit the overall performance of the storage controller associated therewith.

### SUMMARY

A method, apparatus and/or a system of efficient mirroring of data across storage controllers are disclosed.

In one aspect, a method includes multicasting an Input/Output (I/O) data associated with a host computing device through a multicast device associated with a storage controller coupled to another storage controller in a redundant configuration and mirroring, through the multicasting, the I/O data across the storage controller and the another storage controller through a bus utilized to couple the storage controller and the another storage controller. The method also includes transmitting an early write status message to the host computing device following the minoring of the I/O data across the storage controller and the another storage controller. The early write status message is associated with a successful completion of the mirroring of the I/O data across the storage controller and the another storage controller prior to the I/O data being written to a storage device associated therewith.

In another aspect, multicasting an I/O data associated with a host computing device through a multicast device associated with a storage controller coupled to another storage controller through an appropriate bus in a redundant configuration, and generating, through the multicasting, a data set and another data set associated with the I/O data. The data set and the another data set have identical data content but differing control information, and the control information includes a routing information associated with the data set and/or the another data set. The method also includes writing the identical data content of the data set to the storage controller, routing the another data set to the another storage controller through the bus, and writing the identical data content of the another data set to the another storage controller.

In yet another aspect, a storage system includes a host computing device to generate I/O data, a first storage controller including a multicast device associated therewith to multicast the I/O data therethrough, a bus, and a second storage controller coupled to the first storage controller through the bus such that the multicast I/O data is configured to be mirrored across the first storage controller and the second storage controller. The first storage controller and the second storage controller include memories associated therewith to store the mirrored I/O data thereat. The storage system also includes a storage device associated with both the first storage controller and the second storage controller. The first storage controller and/or the second storage controller are configured to transmit an early write status message back to the host computing device following the successful mirroring of the I/O data prior to the I/O data being written to the storage device through the first storage controller or the second storage controller.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a schematic view of a storage controller configuration, according to one or more embodiments.

FIG. 2 is a schematic view of another storage controller configuration, according to one or more embodiments.

FIG. 3 is a flowchart summarizing the communication protocol involved in writing data to storage device(s) utilizing the storage controller configuration of FIG. 2, according to one or more embodiments.

FIG. 4 is a process flow diagram detailing the operations involved in a method of providing redundancy in writing Input/Output (I/O) data from a host computing device to a storage device associated with the storage controller configuration of FIG. 2, according to one or more embodiments.

FIG. 5 is a process flow diagram detailing the operations involved in a method of mirroring I/O data from a host computing device across the storage controllers of FIG. 2, according to one or more embodiments

Other features of the present embodiments will be apparent from the accompanying drawings and from the detailed description that follows.

### DETAILED DESCRIPTION

A method, apparatus and/or system of efficient mirroring of data across storage controllers are disclosed. Although the present embodiments have been described with reference to specific example embodiments, it will be evident that various modifications and changes may be made to these embodiments without departing from the broader spirit and scope of the various embodiments.

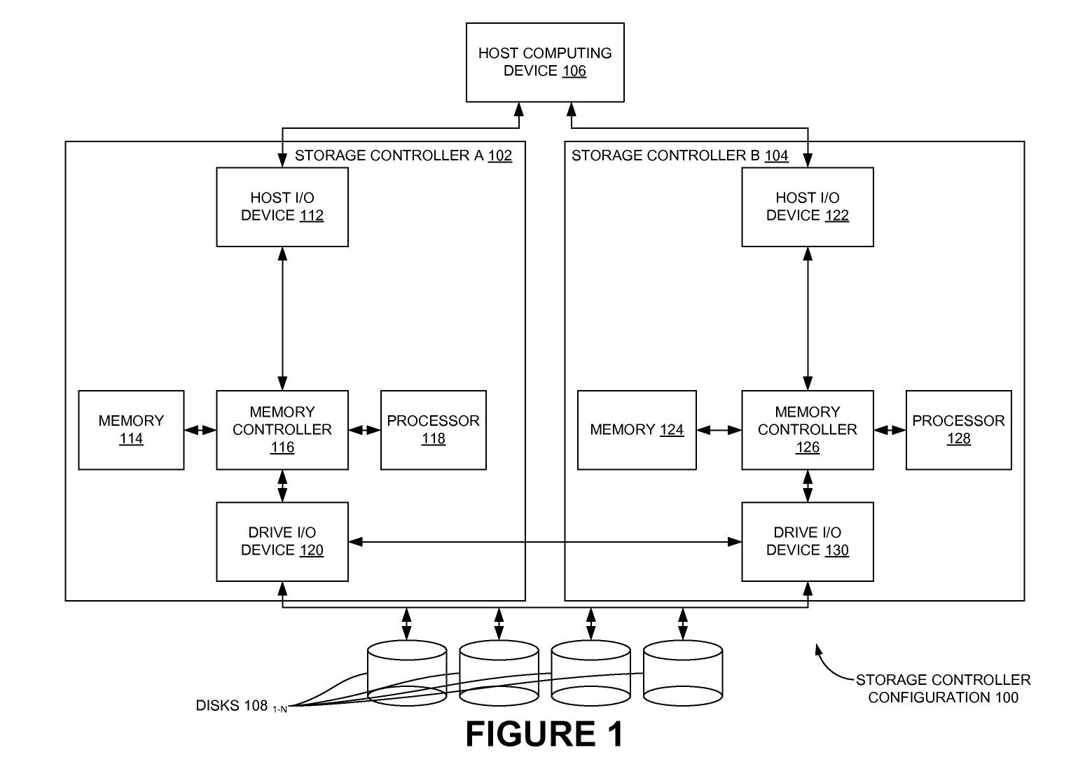

FIG. 1 shows a storage controller configuration 100, according to one or more embodiments. In one or more embodiments, storage controller configuration 100 may include storage controller A 102 and storage controller B 104 configured to write data from a host computing device 106 to one or more storage devices (e.g., disks 108_{1-N}) associated therewith. In one or more embodiments, storage controller A 102 and storage controller B 104 may be paired with one another in a redundant configuration such that whenever one of storage controller A 102 and storage controller B 104 fails, host computing device 106 may still have access to the one or more storage devices associated with the other storage controller. In one or more embodiments, data (e.g., Input/Output (I/O) write data) from host computing device 106 may be mirrored to memories associated with storage controller A 102 and storage controller B 104 to provide for redundancy.

In one or more embodiments, each of storage controller A 102 and storage controller B 104 may include a host I/O device (112, 122) offering a platform to receive data from host computing device 106. In one or more embodiments, each of host I/O device (112, 122) (or, alternately storage controller A 102 and storage controller B 104 respectively) may have a memory (114, 124) and a processor (118, 128) associated therewith. In one or more embodiments, a memory controller (116, 126) may control data transmitted to and/or from memory (114, 124). Here, in one or more embodiments, processor (118, 128) may be associated with memory controller (116, 126). For example, memory controller (116, 126) may be a chip distinct from processor (118, 128) or memory controller (116, 126) may be provided on the same chip as processor (118, 128).

In one or more embodiments, memory controller (116, 126) may interface with a drive I/O device (120, 130) configured to offer a platform for storage I/O data communication with disks 108_{1-N}. In one or more embodiments, I/O write data may be defined as data associated with host computing device 106 that is configured to be written to one or more of disks 108_{1-N}. In one or more embodiments, the aforementioned I/O write data may be mirrored across storage controller A 102 and storage controller B 104 to provide functionality through redundancy during a failure of one of the aforementioned storage controllers.

In one or more embodiments, the I/O write data may first be copied from storage controller A 102 to storage controller B 104 such that both storage controllers have copies thereof before the early write status is returned to host computing device 106. Here, early write status is referred to the status message associated with the completion of the aforementioned write process prior to the writing of the I/O write data to the storage devices (e.g., disks 108_{1-N}). Now, in one or more embodiments, if storage controller A 102 fails, storage controller B 104 may complete the writing of the I/O write data to the storage devices (e.g., disks 108_{1-N}).

To summarize, in one or more embodiments, the abovementioned minoring process may involve three memory transfers. In one or more embodiments, first, the I/O write data may be written to memory 114 of storage controller A 102. In one or more embodiments, then the I/O write data written to memory 114 may be read therefrom prior to being written to storage controller B 104. In one or more embodiments, finally, the I/O write data may be written to memory 124 of storage controller B 104.

As discussed above, it is obvious that to mirror data across storage controllers (e.g., storage controller A 102, storage controller B 104), one storage controller may read I/O write data from a memory thereof and then write the data to a memory associated with another storage controller. For the aforementioned write process, a communication medium is required for transmission of appropriate data (e.g., messages associated with a protocol of communication) between the storage controllers. As the memory on each of the storage controllers may offer limited performance, the additional memory read(s) required to mirror the data across storage controllers may limit the performance thereof.

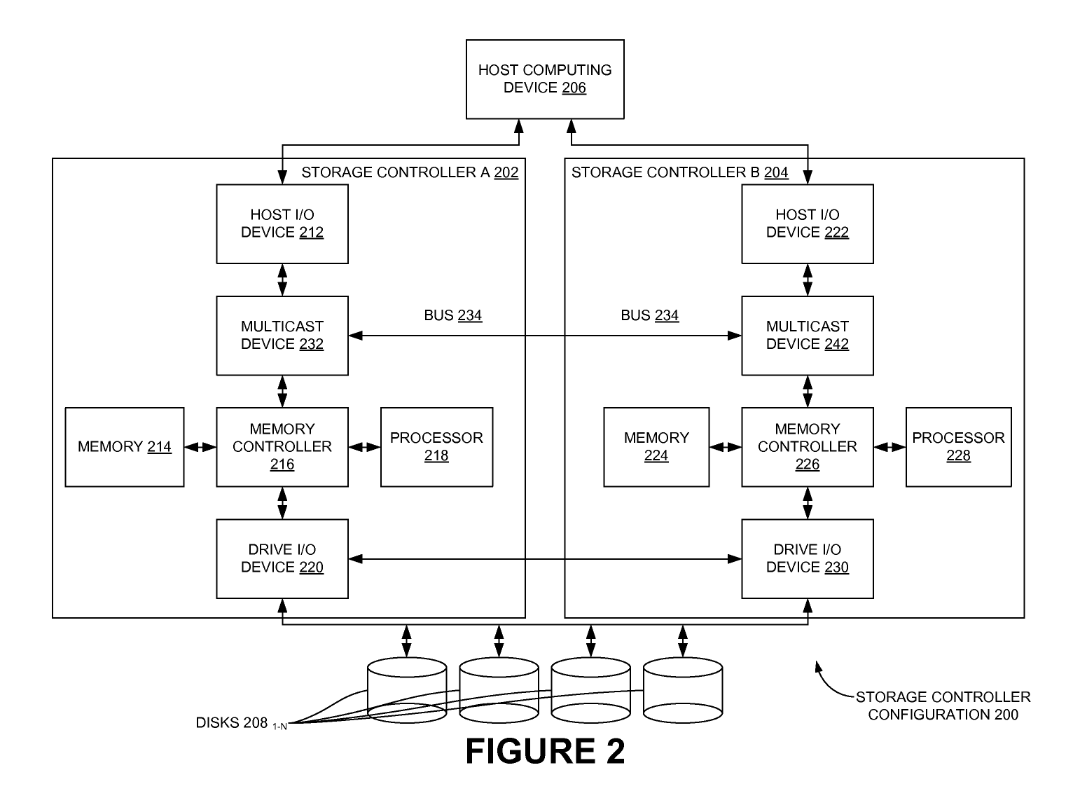

FIG. 2 shows another storage controller configuration 200, according to one or more embodiments. In one or more embodiments, storage controller configuration 200 may also include storage controller A 202 and storage controller B 204, analogous to storage controller configuration 100 having storage controller A 102 and storage controller B 104. Also, in one or more embodiments, host I/O device (212, 222), memory (214, 224), memory controller (216, 226), processor (218, 228), disks 208_{1-N} and drive I/O device (220, 230) are analogous to host I/O device (112, 122), memory (114, 124), memory controller (116, 126), processor (118, 128), disks 108_{1-N} and drive I/O device (120, 130) respectively. In one or more embodiments, memory (214, 224) may include storage locations configured to be addressable through processor (218, 228).

In one or more embodiments, in contrast to storage controller configuration 100, storage controller configuration 200 may have multicast device(s) (232, 242) associated with the storage controller(s) (e.g., storage controller A 202, storage controller B 204), the multicast device(s) (232, 242) being coupled between host I/O device(s) (212, 222) and memory controller(s) (216, 226). In an example embodiment, multicast device(s) (232, 242) may be Peripheral Component Interconnect Express (PCIe) switches. In one or more embodiments, multicast device(s) (232, 242) may enable splitting of the I/O write data into two distinct memory operations prior to the first memory write through multicasting (or, alternately, dual-casting, forking). Multicasting may be defined to be delivery of data simultaneously to plural destinations over a communication link, where copies are created only when the communication link splits.

In one or more embodiments, additionally, storage controller A 202 and storage controller B 204 may be coupled to each other through an appropriate bus 234 to allow for the multicast data to be transferred therebetween. For example, in the case of PCIe switches being employed in storage controller A 202 and storage controller B 204, storage controller A 202 and storage controller B 204 may be coupled to one another through an appropriate additional PCIe bus (example of bus 234) coupling the PCIe switch on storage controller A 202 and the PCIe switch on storage controller B 204. In one or more embodiments, when the I/O write data passes through a multicast device (e.g., multicast device 232; e.g., the I/O write data passes through the multicast device in the form of packets), the I/O write data may be split into two distinct memory write data having identical data content but differing control information. For example, the I/O write data in the form of a packet may be split into two distinct PCIe memory write packets having the same data payload (again, but differing control information).

In one or more embodiments, the differing control information (e.g., routing information) may initiate a memory write (e.g., write to memory 214) of the data content of a distinct memory write data to storage controller A 202 and a routing of the other distinct memory write data to storage controller B 204 through bus 234. In one or more embodiments, data content associated with the other distinct memory write data may be written to memory 224 associated with storage controller B 204. In one or more embodiments, the lack of a need of a memory read operation may reduce the memory bandwidth load on the storage controllers (e.g., storage controller A 202, storage controller B 204). In one or more embodiments, the overall I/O write performance associated with the storage controllers is also increased in storage controller configuration 200 compared to other storage controller configuration(s) (e.g., storage controller configuration 100).

In one or more embodiments, less expensive memory may now be utilized on storage controllers in storage controller configuration 200 when compared to storage controller configuration 100 because of the lack of need for a memory read analogous thereto. It is obvious that the I/O write data may be written to both memory 214 and memory 224 associated with storage controller A 202 and storage controller B 204 respectively prior to the early write status message (associated with the completion of the write(s) to memory 214 and memory 224) being transmitted (e.g., through storage controller A 202 and/or storage controller B 204) to host computing device 206. In one or more embodiments, along with the advantage offered through the early write status message, viz., the lack of a need to write to disks 208_{1-N} prior to returning the early write status message, whenever one of storage controller 202 and storage controller 204 fails (e.g., through failure of memory 214 or memory 224) prior to the I/O write data being written to disks 208_{1-N}, the other storage controller may have the capability to write the aforementioned data to disks 208_{1-N} without any loss therein.

In the example embodiment utilizing the PCIe standard, the multicasting feature defined in the Multicasting ECN for PCIe Base 2.0 specification may allow for packets associated with the I/O write data to be split into two distinct PCIe memory write packets including the same data payload. It is obvious that mirroring may be performed across more than two storage controllers and that, in such cases, the multicasting may involve splitting of the I/O write data into an appropriate number (e.g., >2) of distinct data. Also, storage controller configuration 200 is merely disclosed for the purpose of concept illustration. Variations in implementations of elements including but not limited to the memory controller(s) and processor(s) are within the scope of the exemplary embodiments.

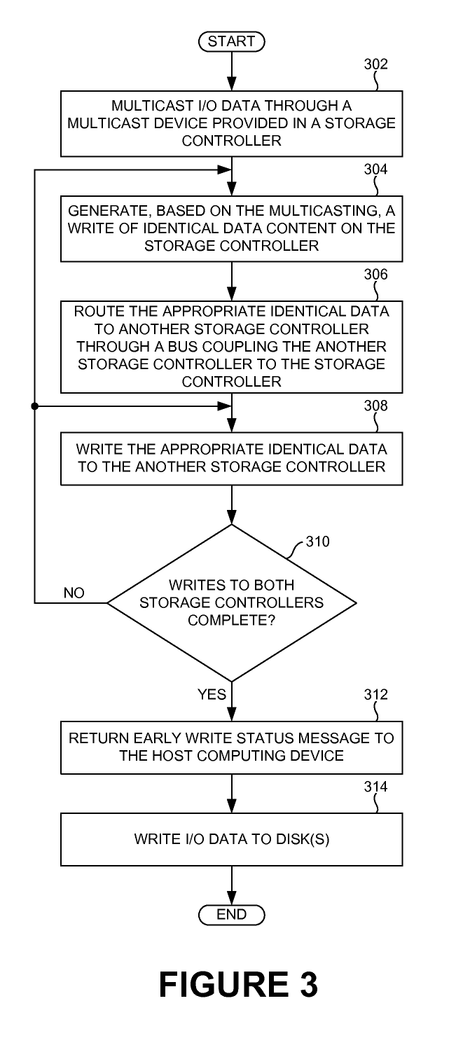

FIG. 3 shows a flowchart summarizing the communication protocol involved in writing data to storage device(s) (e.g., disks 208_{1-N}) utilizing storage controller configuration 200, according to one or more embodiments. In one or more embodiments, operation 302 may involve multicasting I/O write data to be written to storage controller A 202 and storage controller B 204 through a multicast device (e.g., multicast device 232, multicast device 242) provided in a storage controller (e.g., storage controller A 202, storage controller B 204) to generate a distinct pair of identical data having different control information. Here, in one or more embodiments, multicast device (232, 242) may be coupled between host I/O device (212, 222) and memory controller (216, 226) associated with the appropriate storage controller (A 202, B 204). In one or more embodiments, control information may include routing information associated with at least one of the pair of the additional data generated.

In one or more embodiments, storage controller A 202 and storage controller B 204 may be coupled to each other through bus 234. Thus, multicast device (e.g., multicast device 232, multicast device 242) may be provided on each of the storage controllers, despite the identical data being generated through one multicast device associated with a storage controller. In one or more embodiments, operation 304 may involve generating, based on the multicasting, a write of the identical data content to a storage controller (e.g., storage controller A 202; or, alternately, memory 214 of storage controller A 202). In one or more embodiments, operation 306 may involve routing the appropriate identical data to another storage controller (e.g., storage controller B 204) through bus 234 based on the associated control information. In one or more embodiments, operation 308 may involve writing the appropriate identical data to the another storage controller (e.g., storage controller B 204; or, alternately, memory 224 of storage controller B 204).

In one or more embodiments, operation 310 may then involve checking as to whether the writes to both storage controller A 202 and storage controller B 204 have been completed. In one or more embodiments, if yes, operation 312 may then involve returning an early write status message to host computing device 206. The early write status message has already been discussed above and, therefore, discussion associated therewith has been skipped here. In one or more embodiments, operation 314 may involve writing data written to storage controller A 202 and storage controller B 204 to disks 208_{1-N}.

Implementations associated with the exemplary embodiments may not be limited to the PCIe standard. Variations therein are within the scope of the exemplary embodiments. Also, specific details of the PCIe standard (e.g., maintaining routing tables for PCIe switches)/are known to one skilled in the art. Therefore, discussion associated therewith has been skipped for the sake of convenience.

In one or more embodiments, storage controller configuration 200 may be part of a storage system. In one or more embodiments, host computing device 206 may be coupled to storage controller A 202 and/or storage controller B 204 through a computer network (e.g., Internet). It is obvious that the communication protocol therein may have to be modified to suit the computer network.

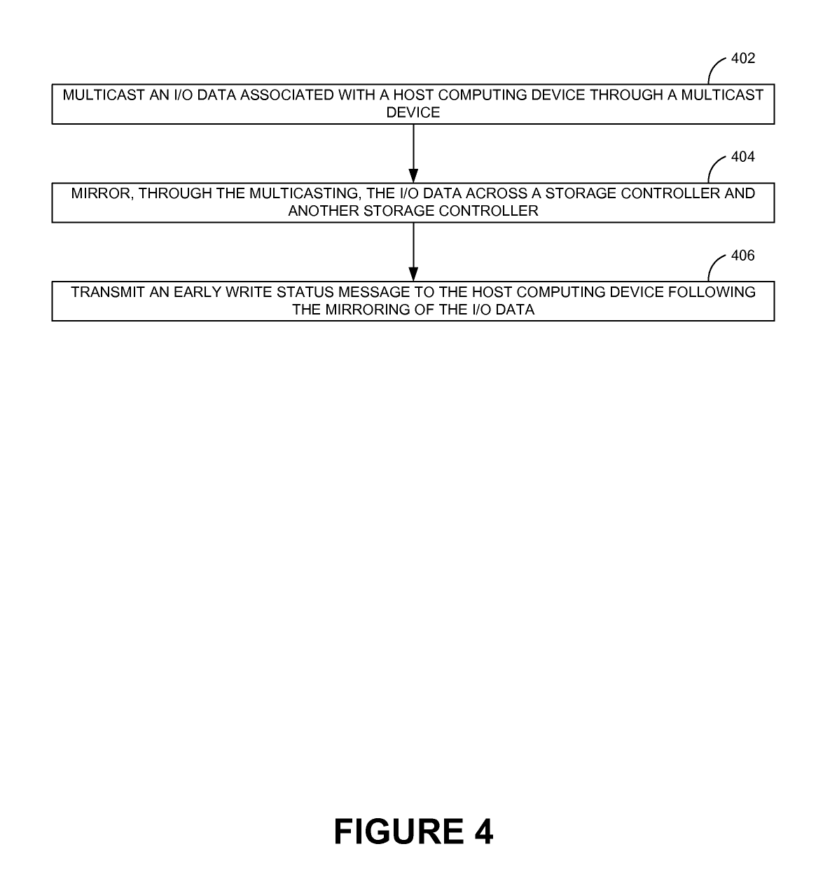

FIG. 4 shows a process flow diagram detailing the operations involved in a method of providing redundancy in writing I/O data from host computing device 206 to a storage device (e.g., disks 208_{1-N}), according to one or more embodiments. In one or more embodiments, operation 402 may involve multicasting the I/O data through a multicast device (e.g., multicast device 232) associated with storage controller A 202 coupled to storage controller B 204 in a redundant configuration. In one or more embodiments, operation 404 may involve minoring, through the multicasting, the I/O data across storage controller A 202 and storage controller B 204 through bus 234 utilized to couple storage controller A 202 and storage controller B 204.

In one or more embodiments, operation 406 may then involve transmitting an early write status message to host computing device 206 following the minoring of the I/O data across storage controller A 202 and storage controller B 204. In one or more embodiments, the early write status message may be associated with a successful completion of the mirroring of the I/O data across storage controller A 202 and storage controller B 204 prior to the I/O data being written to a storage device (e.g., disks 208_{1-N}) associated therewith.

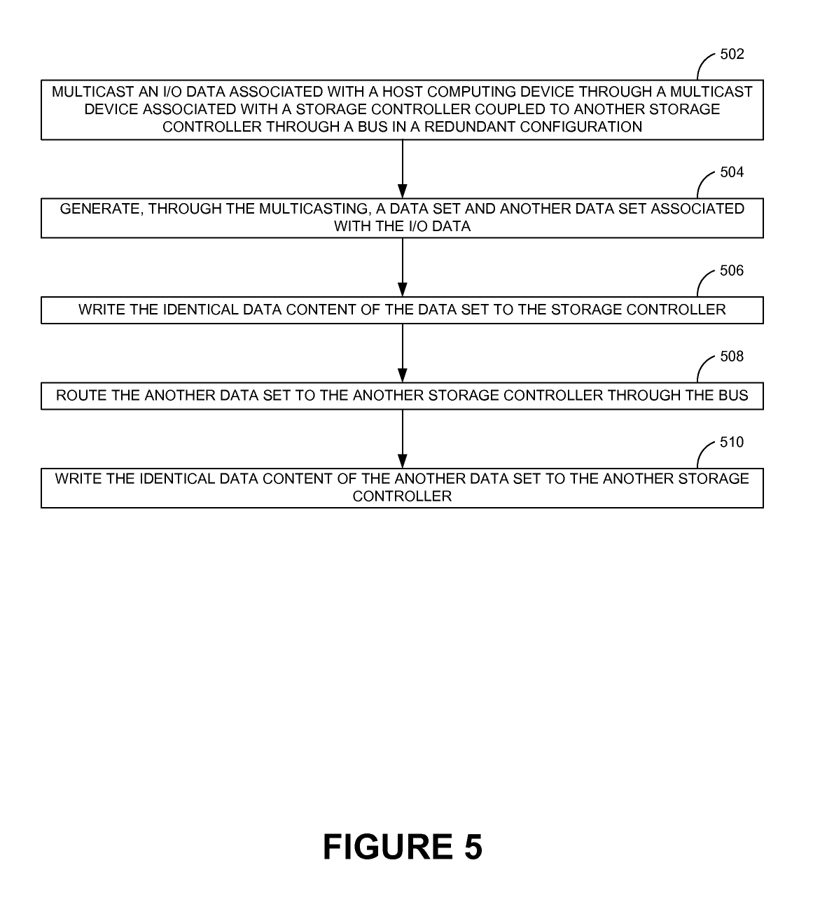

FIG. 5 shows a process flow diagram detailing the operations involved in a method of mirroring I/O data from a host computing device 206 across storage controller A 202 and storage controller B 204, according to one or more embodiments. In one or more embodiments, operation 502 may involve multicasting the I/O data through a multicast device (e.g., multicast device 232) associated with storage controller A 202 coupled to storage controller B 204 through bus 234 in a redundant configuration. In one or more embodiments, operation 504 may involve generating, through the multicasting, a data set and another data set associated with the I/O data, where the data set and the another data set have identical data content but differing control information. In one or more embodiments, the control information may include a routing information associated with the data set and/or the another data set.

In one or more embodiments, operation 506 may involve writing the identical data content of the data set to storage controller A 202. In one or more embodiments, operation 508 may involve routing the another data set to storage controller B 204 through bus 234. In one or more embodiments, operation 510 may then involve writing the identical data content of the another data set to storage controller B 204.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structure and methods may be embodied using transistors, logic gates, and electrical circuits (e.g., application specific integrated (ASIC) circuitry and/or in Digital Signal Processor (DSP) circuitry).

In addition, it will be appreciated that the various operations, processes, and methods disclosed herein may be embodied in a machine-readable medium and/or a machine accessible medium compatible with a data processing system (e.g., a computer system), and may be performed in any order (e.g., including using means for achieving the various operations). Accordingly, the specification and drawings are to be regarded in an illustrative rather than a restrictive sense.

What is claimed is:

1. A method comprising:
multicasting an Input/Output (I/O) data associated with a host computing device through a multicast device associated with a storage controller coupled to another storage controller in a redundant configuration;
mirroring, through the multicasting, the I/O data across the storage controller and the another storage controller through a bus utilized to couple the storage controller and the another storage controller; and
transmitting an early write status message to the host computing device following the mirroring of the I/O data across the storage controller and the another storage controller, the early write status message being associated with a successful completion of the mirroring of the I/O data across the storage controller and the another storage controller prior to the I/O data being written to a storage device associated therewith.

2. The method of claim 1, wherein mirroring the I/O data includes generating, through the multicasting, a data set and another data set associated with the I/O data, the data set and the another data set having identical data content but differing control information, and the control information including a routing information associated with at least one of the data set and the another data set.

3. The method of claim 2, wherein mirroring the I/O data further comprises:
writing the identical data content of the data set to the storage controller;
routing the another data set to the another storage controller through the bus; and
writing the identical data content of the another data set to the another storage controller, the writes to both the storage controller and the another storage controller being completed prior to the generation of the early write status message.

4. The method of claim 2,
wherein the bus is based on a Peripheral Component Interconnect Express (PCIe) standard and the multicast device is a PCIe switch, and
wherein when the I/O data passes the multicast device in the form of packets, the data set and the another data set are generated as distinct PCIe packets having a same data payload associated therewith.

5. The method of claim 1, further comprising coupling the multicast device between a host I/O device associated with the storage controller and a memory controller associated therewith.

6. The method of claim 1, further comprising writing the I/O data mirrored to both the storage controller and the another storage controller to the storage device associated therewith utilizing one of the storage controller and the another storage controller in a functional mode upon a failure of the corresponding other of the storage controller and the another storage controller.

7. A method comprising:
multicasting an I/O data associated with a host computing device through a multicast device associated with a storage controller coupled to another storage controller through an appropriate bus in a redundant configuration;
generating, through the multicasting, a data set and another data set associated with the I/O data, the data set and the another data set having identical data content but differing control information, and the control information including a routing information associated with at least one of the data set and the another data set;
writing the identical data content of the data set to the storage controller;
routing the another data set to the another storage controller through the bus; and
writing the identical data content of the another data set to the another storage controller.

8. The method of claim 7, further comprising transmitting an early write status message to the host computing device following a successful completion of the writes to the storage controller and the another storage controller.

9. The method of claim 8, further comprising writing the I/O data to a storage device associated with the storage controller and the another storage controller following the transmission of the early write status message through one of the storage controller and the another storage controller following a failure of the corresponding other of the storage controller and the another storage controller.

10. The method of claim 7,
wherein the bus is based on a PCIe standard and the multicast device is a PCIe switch, and
wherein when the I/O data passes the multicast device in the form of packets, the data set and the another data set are generated as distinct PCIe packets having a same data payload associated therewith.

11. The method of claim 7, further comprising coupling the multicast device between a host I/O device associated with the storage controller and a memory controller associated therewith.

12. A storage system comprising:
a host computing device to generate I/O data;
a first storage controller including a multicast device associated therewith to multicast the I/O data therethrough;
a bus;
a second storage controller coupled to the first storage controller through the bus such that the multicast I/O data is configured to be mirrored across the first storage controller and the second storage controller, the first storage controller and the second storage controller including memories associated therewith to store the mirrored I/O data thereat; and
a storage device associated with both the first storage controller and the second storage controller,
wherein at least one of the first storage controller and the second storage controller is configured to transmit an early write status message back to the host computing device following the successful minoring of the I/O data prior to the I/O data being written to the storage device through one of the first storage controller and the second storage controller.

13. The storage system of claim 12, wherein when the multicast device enables the multicasting of the I/O data, a data set and another data set associated with the I/O data are generated, the data set and the another data set having identical data content but differing control information, and the control information including a routing information associated with at least one of the data set and the another data set.

14. The storage system of claim 13,
wherein the identical data content of the data set is configured to be written to the first storage controller,
wherein the another data set is configured to be routed to the second storage controller through the bus, and
wherein the identical data content of the another data set is configured to be written to the second storage controller, the writes to both the first storage controller and the second storage controller being completed prior to the generation of the early write status message.

15. The storage system of claim 13,
wherein the bus is based on a PCIe standard and the multicast device is a PCIe switch, and
wherein when the I/O data passes the multicast device in the form of packets, the data set and the another data set are generated as distinct PCIe packets having a same data payload associated therewith.

16. The storage system of claim 12, wherein the first storage controller further comprises a host I/O device and a memory controller configured to be coupled through the multicast device.

17. The storage system of claim 12, wherein the I/O data mirrored to both the first storage controller and the second storage controller is written to the storage device associated therewith utilizing one of the first storage controller and the second storage controller in a functional mode upon a failure of the corresponding other of the first storage controller and the second storage controller.

18. The storage system of claim 12, wherein the storage system further comprises a computer network configured to couple the host computing device to at least one of the first storage controller and the second storage controller.

19. The storage system of claim 12, wherein the storage device is an array of disks.

20. The storage system of claim 12, wherein each of the first storage controller and the second storage controller includes a processor associated therewith to address storage locations in the memory associated therewith, the processor being configured to execute appropriate instructions associated with mirroring the I/O data of the host computing device at the first storage controller and the second storage controller.
